(19) United States
(12) Patent Application Publication
(10) Pub. No.: US 2025/0263608 A1
(43) Pub. Date: Aug. 21, 2025

(54) ENHANCED CIRCULARITY AT ENHANCED ETHYLENE YIELD

(71) Applicant: Chevron U.S.A. Inc., San Ramon, CA (US)

(72) Inventors: Theodorus Ludovicus Michael MAESEN, Spring, TX (US); Cong-Yan CHEN, Kensington, CA (US); Joel E. SCHMIDT, Oakland, CA (US); Kandasamy M. SUNDARAM, Old Bridge, NJ (US)

(73) Assignee: Chevron U.S.A. Inc., San Ramon, CA (US)

(21) Appl. No.: 19/060,173

(22) Filed: Feb. 21, 2025

Related U.S. Application Data
(60) Provisional application No. 63/556,161, filed on Feb. 21, 2024.

(51) Int. Cl. C10G 65/12; C08F 10/02; C10G 1/10

(52) U.S. Cl. CPC C10G 65/12; C08F 10/02; C10G 1/10; C10G 2300/1003; C10G 2300/202; C10G 2300/70; C10G 2300/807; C10G 2400/20; C10G 2400/22

(57) ABSTRACT

Provided is a circular process for converting polyolefins and other waste plastics back into the starting materials for polymers or value-added chemicals. Waste plastics are passed through a pyrolysis reactor to produce a pyrolyzed effluent. The pyrolyzed effluent is separated into offgas, a pyrolysis oil and pitch (or char). Optionally after further washing to remove halogens and other contaminants, the pyrolysis oil is passed to a hydrodehalogenation reactor, followed by a hydroconversion reactor comprising a catalyst comprising an LTA zeolite having an acid site concentration of 1-3 mol/l. Effluent from the hydroconversion reactor can then be sent to a steam cracker for renewed conversion into olefins.

### CROSS REFERENCE TO RELATED APPLICATIONS

The present application claim priority to U.S. Patent Application No. 63/556,161, filed Feb. 21, 2024, the complete disclosure of which is incorporated herein by reference in its entirety.

### TECHNICAL FIELD

A process for upcycling waste plastics or (sorted) municipal waste into the building blocks for polyolefins, polyesters, polystyrenes, polyamides, and polyaramids.

### BACKGROUND

There is an urgent need to improve management of plastic waste by keeping plastics in circulation for longer. The currently predominant route for plastic reuse is mechanical recycle (re-extrude, re-use), but this has limitations in that the resulting re-extruded fibers are shorter and are more of a mixture of fibers than plastics freshly made from monomers. This diversity makes it difficult to design proper additive packages to promote longevity of the recomposed plastics. An alternative to mechanical recycle is chemical recycle, which depolymerizes plastics back into their (oligomers or) monomers. Depending on the type of plastics a variety of chemical recycle technologies are being deployed and are reaching maturity.

Polyolefins such as polyethylene and polypropylene are one of the key building blocks of current societies. Their chemical depolymerization typically requires heating them up in inert atmosphere (pyrolysis). Polyolefins fibers frequently are blended with polyvinylchloride (PVC) fibers to tailor plasticity and thermal properties of the plastics products. In addition, polyolefins can contain bromide-containing fire retardants and fluoride-containing (Teflon®) coatings, which add more halogens. Consequently, plastics pyrolysis processes are tuned toward capturing the halogens that organic halogenides can release. This comprises adding basic (halogen capturing) components to the pyrolysis process and it can include hydrolyzing the organic halogens in the pyrolysis oils to further reduce halogen content. Since steam cracker metallurgy does not accommodate any organic chlorides, a final hydrodehalogenation step remains required before pyrolyzed polyolefins from post-industrial or post-consumer waste can be fed to a steam cracker to make olefin monomers fit to be put back into circulation. Since hydrodehalogenation is necessary, one can do more with hydroprocessing by upgrading the pyrolyzed polyolefins into a circular steam cracker feedstock that generates more olefins than a standard linear (petrochemical naphtha) steam cracker feedstock.

Feedstocks to steam cracker that maximize olefin (particular ethylene) make benefit from a minimum concentration of branched paraffins (iso-paraffins), naphthenics and aromatics. The industry would welcome a stable and efficient catalytic process for hydroconverting pyrolyzed polyolefins into lighter normal paraffins with minimal formation of iso-paraffins. The stability of such a process would create great efficiency and economic value by increasing carbon efficiency through minimizing the methane and the (renewed) pyrolysis oil make associated with steam cracking iso-instead of n-paraffins.

There is also a growing end user demand for circular raw materials that are deemed more sustainable than linear, fossil raw materials such as petrochemical-grade naphtha derived from crude oil, from ethane (harvested from natural gas) or liquid petroleum gas (LPG). Raw materials made from waste materials are frequently considered a step toward closing the raw material cycles in the field of chemicals—as well as fuels. Although mandates on circular raw materials are as yet limited there are clear signs of legislative directives emerging. Currently, there is a limited but growing offering of circular, waste-plastics derived raw materials available to recreate the building blocks of petrochemicals. These circular raw materials are typically not cost competitive with the conventional linear raw materials, which has limited the development of circular chemicals and fuels. Olefins such as ethylene, propylene, and butylene are the intermediates for making polyolefins. Polyolefin demand has been growing slightly ahead of global gross domestic product (GDP), indicating that polyolefins are one of the key pillars of the global economy. Providing polyolefins from post-industrial and post-consumer waste would be of great value to the industry and to the environment. And providing a process that can satisfy both of these urgent needs in a cost-effective manner would be of particular value to the petrochemical industry.

### SUMMARY

Provided is a process for upcycling circular feedstocks into starting materials for polymers or value-added chemicals. The process comprises providing a waste plastics-derived feedstock which is then passed through a pyrolysis reactor to thermally crack at least a portion of the waste feedstock and produce a pyrolyzed effluent. The pyrolyzed effluent is separated into off-gas, circular pyrolysis oil and char, pitch, or both.

The circular pyrolysis oil can be subjected to a hydrolysis step to further reduce the halogen levels to below 25 ppm, and is then sent to a hydrodehalogenation reaction to reduce halogen levels to below 5 ppm, and in one embodiment below 1 ppm. Any known, suitable method of hydrodehalogenation (HDH) can be used, catalytic, electrocatalytic, radical induced. Base metal or noble metal catalysts are suitable for converting the last remaining halogens into their gaseous acids or into their ammonium salts. The hydrodehalogention reaction eliminates any halogens left from errant polyvinyl chloride fibers, brominated fire retardants, halobutyl, and Teflon™, to eliminate errant organic silicon-compounds from silicon oils and silicon greases, organic nitrogen components from polymers like polyamides (such as Nylon™), polyacrylamide, polyaramids, styrene acrylonitrile (SAN), acrylonitrile butadiene styrene (ABS), acrylonitrile styrene acrylate (ASA), and other synthetic rubbers such as acrylonitrile butadiene (NBR). Such treatment should also eliminate nearly all sulfur originating from polysulfone and polysulfide rubbers, and concurrently hydrogenate olefinic bonds. The hydrohalogenation circular product is then sent to hydroshortening of the n-alkane moieties, which process is run in the presence of an LTA type zeolite, which zeolite has an acid site concentration of at least around 2.7 mol/l or greater. In one embodiment, the acid site concentration is in the range of from 2.6 mol/l to 3.0 mol/l; and in another embodiment in the range of from 2.6 mol/l to 2.8 mol/l. A chosen boiling range of n-paraffins is then collected from the hydroprocessing reactor. The range generally comprises C₂-C₆ n-paraffins. Any isoparaffins or naphthenics can then be separately subjected to destructive cracking, if desired. The collected C₂-C₆ n-paraffins can then be passed to processing for preparation of value-added chemicals and polymers. In one embodiment, the circular n-paraffins can be passed to a naphtha steam cracker with good results including improved ethylene production.

Among other factors the present process is stable and efficient in creating a circular economy using post-industrial or post-consumer waste. The process uses pyrolysis followed by hydrohalogenation and then hydroconversion using an LTA zeolite. The naphtha products from the hydroconversion can then be used to prepare value-added chemicals, including providing lower alkene production, especially ethylene, when using a naphtha steam cracker. It has been surprisingly found that the LTA zeolite used, with an acid site concentration of about 2.7 mol/l, can reduce n-paraffins, including long, polyethylene-derived n-paraffins in high yield to the desired naphtha range of C₂-C₆ n-paraffins continuously, for months on end, without losing its catalytic activity. The reaction is stable and does not exhibit any issues even with feeds having extremely long n-paraffins. By providing a suitable feedstock for a naphtha steam cracker, the preparation of ethylene and other lower olefins as chemical building blocks can be efficiently realized in good yield as part of a circular economy employing a feedstock that would otherwise have gone to waste.

### BRIEF DESCRIPTION OF THE DRAWINGS

FIG. 1 depicts a process for pyrolysis of post-industrial or post-consumer waste.

FIG. 2 depicts a process for upcycling plastics-derived pyrolysis oil into chemical building blocks.

FIG. 3 depicts the composition of a C₁₂⁺ feed to hydroconversion.

FIG. 4 graphically depicts the results achieved from hydronormalizing a largely n-C₁₂⁺ feed.

FIG. 5 graphically depicts a steam cracker production.

### DETAILED DESCRIPTION

### Definitions

Steam cracking is a petrochemical process in which saturated hydrocarbons are broken down into smaller, often unsaturated, hydrocarbons. It is the principal industrial method for producing the lighter alkenes (or commonly “olefins”), including ethylene and propylene. Steam cracker units are facilities in which feedstocks such as ethane, propane, butane, liquefied petroleum gas (LPG), and naphtha are thermally cracked or pyrolyzed in the presence of steam by a short residence time in a furnace at high temperature to produce lighter hydrocarbons. After the cracking temperature has been reached, the gas is quickly quenched to stop the reaction in a transfer line heat exchanger or inside a quenching header using quench oil. The feed composition, the hydrocarbon-to-steam ratio, the cracking temperature, and furnace residence time determine the product composition. Light hydrocarbon feeds such as ethane, LPGs, or light naphtha yield mostly lighter alkenes, including ethylene, propylene, and butadiene. Heavier hydrocarbon (full range and heavy naphtha or even heavier oil fractions) feeds yield some of these same products, but also aromatic pyrolysis oils.

Olefins such as ethylene, propylene and butylene are the raw materials of polyolefins. Polyolefins are one of the key building blocks of the global economy. Illustrating its critical roll to economic growth, steam cracking capacity tends to grow slightly ahead of global gross domestic product (GDP). Ethylene capacity in 2021 was 150,000 kiloton/annum (kta) and is growing annually at 6000-8000 kta of ethylene, produced in ever larger facilities. A current state-of-the-art cracker can produce 2000 kta of ethylene. At such large volumes feedstocks that make incrementally more ethylene have large financial benefits. Providing these feedstocks from circular sources would render the ethylene and other olefins circular and even more beneficial.

A “naphtha” steam cracker is generally limited to feedstocks in the naphtha boiling range of 32-193° C. (C₄-C₁₀). The majority of commercial steam crackers are “naphtha” (steam) crackers.

Hydroconversion and hydro-shortening: A catalytic process which operates at pressures greater than atmospheric in the presence of hydrogen and which converts normal paraffins into lighter normal paraffins with a minimum of isomerization and without excessive formation of methane. This can also be referred to as hydro-normalization. Hydrotreating and hydrocracking are distinctly different catalytic processes, but which also operate at pressures greater than atmospheric in the presence of hydrogen. Hydrocracking converts normal paraffins into lighter products comprising significant amounts of iso-paraffins. Hydrotreating does not convert significant quantities of the feedstock to lighter products but does remove impurities such as sulfur- and nitrogen-containing compounds. Also in comparative contrast, thermal cracking converts normal paraffins into lighter products with a minimum of branching, but this process does not use a catalyst, typically operates at much higher temperatures, forms more methane, and makes a mixture of olefins, normal paraffins, and aromatics.

An LTA (Linde Type A) zeolite is a zeolite that has voids greater than 0.50 nm in diameter, and apertures characterized by a longest diameter of less than 0.5 nm and a shortest diameter of more than 0.30 nm. Such LTA zeolites are described in the Atlas of Zeolite Structure Types, Fourth Revised Edition 1996.

An “aperture” in a zeolite is the narrowest passage through which an absorbing or desorbing molecule needs to pass to get into the zeolite's interior. The diameter of the aperture, dₐₚₚ (nm), is defined as the average of the shortest, dₛₕₒᵣₜ (nm), and the longest, d_{long} (nm) axis provided in the IZA (International Zeolite Association) Zeolite Atlas (http://www.iza-structure.org/databases/). Both normal- and iso-paraffins with a methyl group can pass through apertures with a d_{long}≥0.50 nm, but only normal-paraffins can pass through apertures with d_{long}<0.50 nm provided dₛₕₒᵣₜ>0.30 nm.

Apertures provide access to “voids”, the wider parts in the zeolite topology. The diameter of the void, d_{void} (nm), is characterized by the maximum diameter of a sphere that one can inflate inside such a void as per the IZA Zeolite Atlas (http://www.iza-structure.org/databases/). This characterizes, e.g., a fairly spherical LTA-type void (or cage) as one with a diameter of 1.1 nm, and an elongated AFX-type void as one with a spherical diameter of 0.78 nm. Voids are defined as cages if d_{void}/dₐₚₚ≥1.4 nm/nm. These apertures help define a LTA zeolite.

The circular feedstock is pyrolyzed in order to produce primarily a circular oil. The pyrolysis is generally run at a medium temperature in the range of from 350° C. to 700° C., in one embodiment from 500° C. to 650° C., with the pyrolysis of the waste polymers requiring a long residence time, in either a single or multiple stages (see WO2023200961 and WO2023137068. The pyrolysis vapors are then rigidly cooled to provide the circular oil product. Smaller amounts of pitch are also created, but it is the circular oil that is the primary product, and which is then passed on to a hydrodehalogenation (HDH) reaction. The circular oil comprises errant organic chlorides, bromides, and fluorides, methyl silanes, siloxanes, organic nitrogen and sulfur containing polymers and oligomers. In the HDH reaction, the carbon chemical structures comprising these heteroatoms in the circular oil are broken down and the heteroatoms are removed to leave essentially a hydrocarbon. Concurrent hydrogenation of olefinic bonds also occur thereby creating n-paraffins.

The term “circular” refers to feedstocks that are part of a circular instead of a linear economy i.e., an economy that minimizes waste by using end of life products as raw materials for the next cycle of usage.

An exemplary composition is produced from starting materials of post-industrial or post-consumer origin using, for example, a process first comprising a hydrodehalogenation (HDH) step for decomposing the structure of the halogenated oligomer, polymer or smaller moiety, and for removing chloride, bromide, fluoride, silicon, nitrogen, and sulfur compounds, concurrently hydrogenating the olefinic bonds. The product can be fractionated by distillation to give the desired fractions.

Circular raw materials from waste plastics originating from both industry and consumers may be used as the starting waste material. The raw material may be selected from predominantly polyethylene, polypropylene, styrene. Halogen- and oxygen-containing materials (such as lignocellulose (paper) or polyethylene terephthalate (PET)) need to be avoided.

In the HDH step, hydrogen gas and the pyrolysis oil are passed to the HDH catalyst bed either in countercurrent or concurrent manner. In the HDH step, the pressure and the temperature range, for example, is between 20 and 150 bar, and between 200 and 500 degrees centigrade, respectively. In the HDH step, any suitable hydrodehalogenation catalysts may be used.

After the HDH step, the long n-paraffins can be separated, or the HDH product stream comprising n-paraffins can be forwarded to the next step. As noted above, the circular raw material can be originated from industry or consumers. The material can be selected from sorted municipal waste with various degrees of pre-sorting in plastic types, but more omnivorous pyrolysis processes that can digest a broader variety of feedstocks are preferred.

The pyrolyzing is carried out by contacting the waste plastic feedstock in a pyrolysis zone at pyrolysis conditions, where at least a portion of the feed(s) is cracked, thus forming a pyrolysis zone effluent comprising primarily olefins, paraffins, and aromatics. Pyrolysis conditions include a temperature of from about 350° C. to about 700° C., preferably from about 450° C. to about 650° C. Conventional pyrolysis technology teaches operating conditions of above-atmospheric pressures. See e.g., WO2023200961 and WO2023137068. Accordingly, in some embodiments where such control is desired, the pyrolysis pressure is sub-atmospheric.

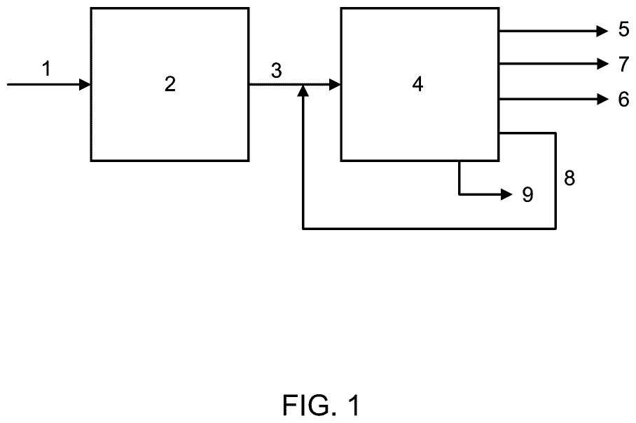

FIG. 1 shows a diagram of pyrolysis of a waste plastics circular feedstock 1 in accordance with the present process. The waste plastics feedstock 1 is processed 2 to provide a suitable circular feedstock 3 for pyrolysis that is converted in a pyrolysis unit 4 to offgas 5 and pyrolysis oil (liquid product) 6. The offgas 5 from the pyrolysis unit can be used as fuel to operate the pyrolysis unit. A distillation unit in the pyrolysis unit separates the pyrolysis oil to segregate the liquid from most of the remaining solids (both microplastics and pitch) and produces naphtha and diesel 7 products, leaving a heavy pyrolysis oil fraction 8. The heavier fraction 8 of the pyrolysis oil can be recycled back to the pyrolysis unit to maximize the circular oil yield. Pitch 9 is removed from the pyrolysis unit 4. The heavy fraction 8 is rich in long chain, linear hydrocarbons, and is very waxy (i.e., forms a (semi-) solid upon cooling to ambient temperature). The pyrolysis oil 6 can then be forwarded/transported to a hydroconversion reactor for clean up or blended at low concentrations into a refinery or steam cracker stream.

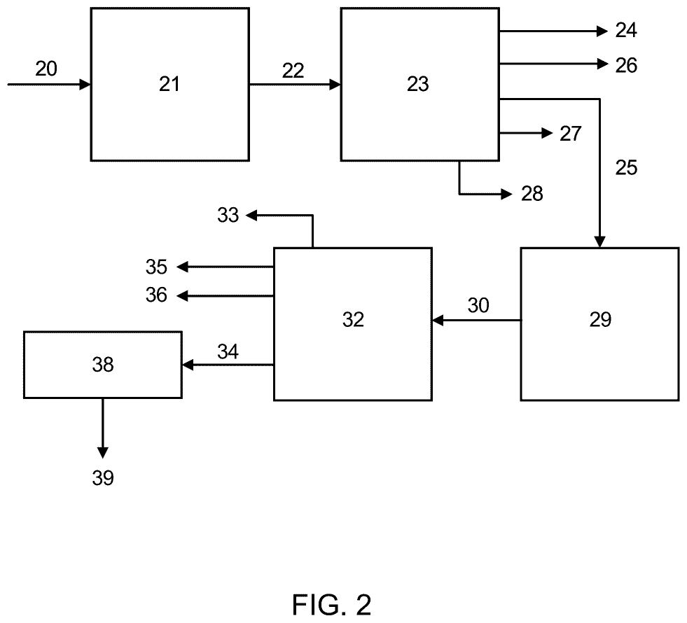

FIG. 2 shows the present integrated process, in which pyrolysis, optionally with recycle, is integrated with hydro-normalization to produce a steam cracker feed. The product from the steam cracker may be used for effective polyethylene production. In FIG. 2, mixed waste plastics 20 are sorted together 21 to provide a suitable circular feedstock. The cleaned waste plastic circular feedstock 22 is converted in pyrolysis unit 23 to offgas 24 and pyrolysis oil 25 (liquid product) and optionally wax (solid product at ambient temperature). The offgas 24 from the pyrolysis unit can be used as fuel to operate the pyrolysis unit 23. The pyrolysis oil may be separated, generally at an on-site distillation unit in the pyrolysis unit 23, into a naphtha/diesel fraction 26, and a heavy fraction 27. Char 28 is removed from the pyrolysis unit 23. Pyrolysis oil 25 from pyrolysis unit 23 is hydrodehalogenated (HDH) or hydrolyzed in reactor 29, with the product 30 subsequently hydroconverted in hydroconversion reactor 32, producing offgas 33 and product stream 34 having an increased lighter (e.g., C₂ to C₆) n-paraffin content. Liquified petroleum gas (LPG) 35 and naphtha 36 streams may be separately produced from the hydroconversion. The n-paraffin product stream 34 is fed to steam cracker 38 and pyrolyzed into a steam cracker product comprising lower olefins 39 (e.g., ethylene).

Any known, suitable method of hydrodehalogenation can be used, catalytic, electrocatalytic, radical induced. A palladium catalyst reaction is used in one embodiment. The hydrodehalogenation reaction eliminates any halogens left from errant polyvinyl chloride fibers, brominated fire retardants, halobutyl, and Teflon™, to eliminate errant organic silicon-compounds from silicon oils and silicon greases, organic nitrogen components from polymers like polyamides (such as Nylon™), polyacrylamide, polyaramids, styrene acrylonitrile (SAN), acrylonitrile butadiene styrene (ABS), acrylonitrile styrene acrylate (ASA), and other synthetic rubbers such as acrylonitrile butadiene (NBR). Such hydrogenation should also eliminate nearly all sulfur originating from polysulfone and polysulfide rubbers, and concurrently hydrogenate olefinic bonds.

The next step of the present process involves the hydronormalization of the hydrodehalogenated paraffin product by hydroconverting normal paraffins into lighter normal paraffins with minimal formation of iso-paraffins. The process step comprises hydroconverting the hydrodehalogenated feedstock under hydrocracking conditions, in the presence of a LTA zeolite catalyst, where the zeolite has voids greater than 0.50 nm in diameter, accessible through apertures characterized by a longest diameter of less than 0.50 nm and a shortest diameter of more than 0.30 nm. The present LTA zeolite also exhibits an acid site concentration of about 2.7 mol/l or greater. The present zeolite can be, and is preferably, loaded with 0.1 to 0.5 wt. % Pd. The zeolite can be impregnated with any hydrogenation function metal.

It is the zeolite base into which the metal is loaded that is critical to the present processes. For it has been found that the present LTA zeolite catalyst in accordance herewith can provide the high conversion and minimal formation of iso-paraffins. It has been found that the key features of the catalyst zeolite include access to a pore system through apertures of a size less than 0.45 nm, and with the pore system containing voids greater than 0.50 nm in diameter. In another embodiment, the zeolite has voids greater than 0.50 nm in diameter, which are accessible through apertures characterized by a longest diameter of less than 0.5 nm and a shortest diameter of more than 0.30 nm. The LTA-type zeolite has such a zeolite framework. The present LTA zeolite must also exhibit an acid site concentration of at least about 2.7 mol/l. In one embodiment, the acid site concentration is in the range of 2.6 mol/l to 3.0 mol/l, and in another embodiment in the range of 2.6 mol/l to 2.8 mol/l.

Zeolite A (Linde Type A, framework code LTA) is one of the most used zeolites in separations, adsorption, and ion exchange. This structure contains large spherical cages (diameter ˜11.4 Å) that are connected in three dimensions by small 8-membered ring (8MR) apertures with a diameter of 4.1 Å. LTA is normally synthesized in hydroxide media in the presence of sodium with Si/Al˜1. By changing the cation, the limiting diameter of the 8MR apertures can be tuned, creating the highly used series of adsorbents 3A (potassium form, 2.9 Å diameter), 4A (sodium form, 3.8 Å diameter) and 5A (calcium form, 4.4 Å diameter) that are used to selectively remove species such as water, NH₃, SO₂, CO₂, H₂S, C₂H₄, C₂H₆, C₃H₆ and other n-paraffins from gases and liquids. While LTA is used in vast quantities for the aforementioned applications, the low framework Si/Al ratio and subsequent poor hydrothermal stability limits its use under more demanding process conditions that are commonly found in catalytic applications. Yet surprisingly, the present process is found to be stable and efficient using an LTA zeolite with the requisite acid site concentration.

The stability of LTA zeolites with 0.4 nm wide constrictions in hydrocracking n-alkanes longer than n-hexane (n-C₆) is stunning. Based on 3 months of operation without activity loss after line-out, current models indicate that a catalyst based on LTA-type zeolite would exhibit the typical run length of 2-4 years for base metal catalyst formulations and of 10-15 years for noble metal catalyst formulations at typical feeds and conditions. The catalyst sustainably hydrocracks extremely long n-paraffins, such as C₂₃⁺ in length. The stability of the hydrocracking process on the LTA-type zeolite catalyst is surprising because it is well-established that a (de) hydrogenation function needs to activate n-paraffins into n-olefins, and that these n-olefins need to enter ˜11 nm wide LTA-type cages before isomerizing into iso-olefins (see J. E. Schmidt et al, ACS Catalysis vol. 13, 2023 pp. 6710-6720). These iso-olefins are trapped inside the LTA-type cages, for they are too large to egress through the ˜5 nm wide LTA-type windows (see P. B. Weisz, V. J. Frilette, J. Phys. Chem. vol. 64, 1960, p. 382). Well-established mechanisms explain how iso-olefins crack into mixtures of iso-paraffins, iso-olefins, n-paraffins and n-olefins (J. Weitkamp, P. A. Jacobs, J. A. Martens, Appl. Catal. vol. 8, 1983, pp. 123-141). An iso-paraffin would require activation into an iso-olefin to enable isomerization into an n-olefin and escape from the LTA-type cage. Without a noble metal function iso-paraffins would accumulate inside the LTA-type cages, blocking access to the zeolite and deactivating the catalyst. Surprisingly, this deactivation was not observed, so that the catalyst sustainably converted longer n-paraffins into desirable linear paraffins in the C₂-C₆ carbon number range.

The discovered stability of LTA zeolites with 0.4 nm wide constrictions that sustainably hydrocrack n-heptane (n-C₇) and longer n-alkanes out of polyolefin-derived feedstocks into small linear paraffins is not intuitive. It is not intuitive because n-C₇ and longer n-alkanes inherently hydrocrack into branched alkanes. This would imply that the primary branched alkene and alkane products would have further isomerized into n-alkenes so as to egress through 0.4 nm wide constrictors. At the current state of theory, it is not clear what mechanism would be involved to let them egress.

The discovered hydroprocessing stability of LTA zeolites with an acid concentration as high as 2.7 mol/l is another surprise. Previously it has been shown that the stability is inversely proportional to acid concentration, and the longheld belief is that stable operation requires an acid concentration of at most 1.8 mol/l. At acid concentrations higher than 1.8 mol/l, catalysts are supposed to coke up or crumble. Lowering the acid site concentration with sodium and calcium cations, however, results in unstable operation.

The rock-stable operation of LTA-type zeolite (for 3 months, 6 months, 2 years or longer before needing to be replaced) with an acid concentration as high as 2.7 mol/l (well above the historically suggested 1.8 mol/l threshold) in the hydro-normalization of n-alkanes as long as n-C₂₂ remains (well above the historically suggested n-C₆ threshold) remains a bit of a mystery and surprise. Yet this is what has been discovered.

The LTA catalyst useful in the present processes can typically contain a catalytically active hydrogenation metal. The presence of a catalytically active hydrogenation metal leads to product improvement, especially IV and stability. Typical catalytically active hydrogenation metals include chromium, molybdenum, nickel, vanadium, cobalt, tungsten, zinc, platinum, and palladium. The metals platinum and palladium are especially preferred, with platinum most especially preferred. If platinum and/or palladium is used, the total amount of active hydrogenation metal is typically in the range of 0.1 wt. % to 5 wt. % of the total catalyst, usually from 0.1 wt. % to 2 wt. %.

The zeolite is loaded with a hydrogenation function metal or a mixture of such metals. Such metals are known in the art and have been discussed generally earlier. The preferred metal is typically either a noble metal, such as Pd, Pt, and Au, or a base metal, such as Ni, Mo and W. A mixture of the metals and their sulfides can be used. The loading of the zeolite with the metals can be accomplished by techniques known in the art, such as impregnation or ion exchange. The hydrogenation function metal is loaded on such a selected zeolite to create the catalyst. The created catalyst can then be used in the hydroconversion process.

In an embodiment, the feedstock's aromatics and organic nitrogen and sulfur content is reduced. This can be achieved by hydrotreating the feedstock prior to the hydroconversion. Contacting the feedstock with a hydrotreating catalyst may serve to effectively hydrogenate aromatics in the feedstock and to remove N- and S-containing compounds from the feed.

The conditions under which the hydroconversion step of the present process in reactor 28, i.e., the hydronormalization reaction, is carried out will generally include a temperature within a range from about 390° F. to about 800° F. (199° C. to 427° C.). In an embodiment, the temperature is in the range from about 550° F. to about 700° F. (288° C. to 371° C.). In a further embodiment, the temperature may be in the range from about 590° F. to about 675° F. (310° C. to 357° C.). The pressure may be in the range from about 50 to about 5000 psig, and typically in the range from about 100 to about 2000 psig.

The products recovered from the hydroconversion, which are normal paraffin rich, can include some clean LPG and clean naphtha. Some offgas may also be a product. The products can then be passed to a steam cracker. Using the present LTA zeolite catalyst provides a C₂-C₆ product in very high yields, which product can be easily collected from the hydronormalization process.

The next step is a steam cracking step in a naphtha steam cracker. The steam cracking process is known in the art. Steam cracking a hydrocarbon feedstock produces olefin streams containing olefins such as ethylene, propylene, and butenes. The present hydroconversion process provides an excellent feedstock for a steam cracker, allowing for maximum ethylene production.

In steam cracking, a gaseous or liquid hydrocarbon feed like naphtha, LPG, or ethane is diluted with steam and briefly heated in a furnace in the absence of oxygen. Typically, the reaction temperature is very high, at around 850° C. The reaction occurs rapidly: the residence time is on the order of milliseconds. Flow rates approach the speed of sound. After the cracking temperature has been reached, the gas is quickly quenched to stop the reaction in a transfer line heat exchanger or inside a quenching header using quench oil.

The products produced in the reaction depend on the composition of the feed, the hydrocarbon-to-steam ratio, and on the cracking temperature and furnace residence time. Light hydrocarbon feeds such as ethane, LPGs, or light naphtha give mainly lighter alkenes, including ethylene, propylene, and butadiene. Heavier hydrocarbon (full range and heavy naphthas as well as other refinery products) feeds give some of these same products, but also those rich in aromatic hydrocarbons and hydrocarbons suitable for inclusion in gasoline or fuel oil.

If ethylene polymerization is desired, the process of FIG. 2 depicts the production of a steam cracker product that may be used to produce polyethylene. For example, ethylene 39 from the steam cracker 38 can be recovered and used as a chemical or passed to ethylene polymerization to make polyethylene and polyethylene products.

The following examples are provided in order to further illustrate the present process. However, the examples are not meant to be limiting.

### Example 1

### Example of LTA Zeolite Based Noble Metal Catalyst

A catalyst was made by extruding 50 wt. % LTA zeolite with 50-wt-% alumina (Pural TH80 from Sasol). The KAQ-type extrudates were loaded with 0.5 wt. % Pd. The LTA zeolite used had an acid site concentration of about 2.7 mol/l.

### Example 2

### Hydronormalize the Feedstock

A process to selectively hydronormalize the long n-paraffins in a feedstock into particularly C₂-C₆ n-paraffins has been discovered. The process thereby provides a tailored feedstock for a naphtha steam cracker, which selectively pyrolyzes the C₂-C₆ n-paraffins to monetize these hydronormalized products.

Hydronormalization is accomplished through hydroprocessing a paraffin feedstock obtained by hydrodehalogenation of a pyrolysis oil made from mostly polyolefins. The hydroprocessing catalyst can be the LTA zeolite catalyst described in Example 1, comprising a LTA zeolite with an optimum acid site concentration around 2.7 mol/l. Key features of the hydronormalization process are that the catalyst selectively converts longer normal paraffins in the feed into C₂-C₆ n-paraffins. In the present example, the feed has an initial boiling point of 390° F., thus the shortest n-paraffin in feed is n-dodecane (or n-C₁₂ with a 421° F. boiling point, whereas n-undecane or n-C₁₁ exhibits a 385° F. boiling point).

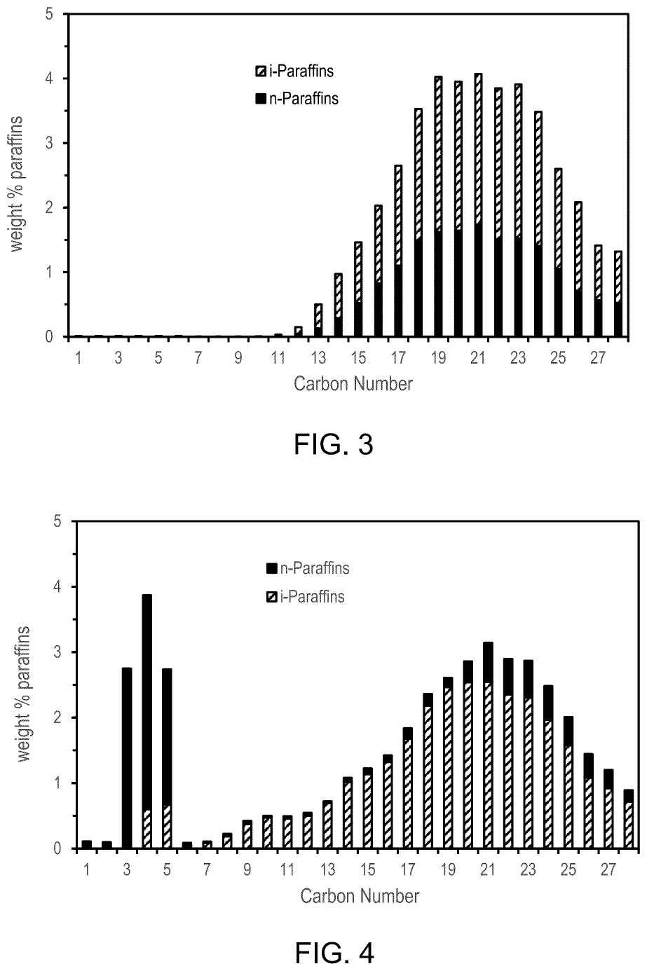

See FIG. 3 which shows a feed exclusively containing n-C₁₂^{plus} with negligible n-C₁₂^{minus}. The products at 81% n-C₁₂^{plus} conversion are nearly exclusively C₂-C₅ n-paraffins. See FIG. 4.

Contrary to the expectations of the art, the present LTA zeolites have been surprisingly found to not exhibit a dramatic preference for processing n-paraffins up to the length that could easily fit inside a single LTA cage, which would limit the length of readily hydrocracked n-paraffins to that of n-tricosane or n-C₂₃ (716° F. boiling point). Longer n-paraffins (n-triaocontane or n-C₃₀, 840° F. boiling point and longer) are still successfully processed. In addition to a remarkable selectivity for hydrocracking selectively n-C₁₂ and longer n-alkanes, the catalyst also makes some minimal i-paraffins.

### Example 3

### Example of Steam Cracker Feed Properties.

A hydrotreated vacuum gasoil is hydroprocessed into an improved steam cracker feed as described in Table 1 below at 1550 psia H₂, 1.6 LHSV, 5100 scf/b H₂. A steam cracker feed produced at 60% n-C₁₂⁺ conversion in the present hydro-normalization step is characterized in Table 1 as follows:

TABLE 1

| | Feed | Hydroprocessed |
|---|---|---|
| API (°) | 35.4 | not measured |
| S (ppm-wt) | 5.3 | <0.3 |
| N (ppm-wt) | <0.3 | <0.3 |
| | Wt % | Wt % |
| Composition | | |
| Methane | 0.00 | 0.03 |
| Ethane | 0.00 | 0.04 |
| Propane | 0.00 | 1 |
| i-Butane | 0.00 | 0.2 |
| n-Butane | 0.00 | 1.29 |
| C4− | 0.00 | 2.56 |
| C5-180′ F. | 0.00 | 2.2 |
| 180-350′ F. | 0.00 | 0.59 |
| 350-500′ F. | 7.2 | 9.58 |
| 500′ F.+ | 92.8 | 86.13 |
| C5+ | 100.0 | 98.5 |
| WLP Dist, by Wt % | | |
| 0.5/5% | 392/478 | 95/445 |
| 10/30% | 519/606 | 495/598 |
| 50% | 666/ | 660/ |
| 70/90% | 719/799 | 716/796 |
| 95/99.5% | 842/955 | 840/956 |

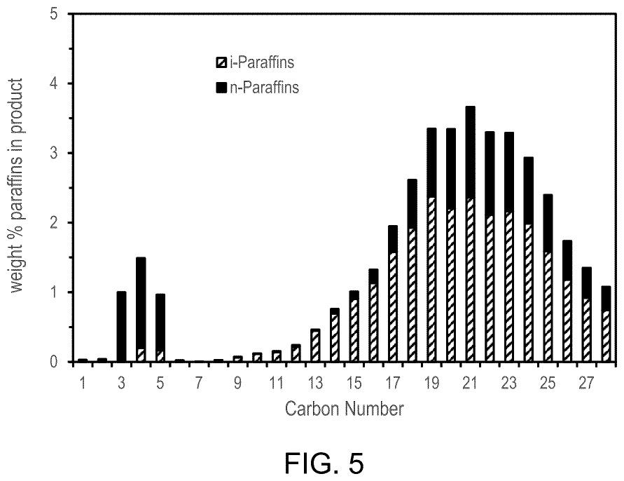

The distribution between n- and iso-paraffins as determined by GC×GC is as shown in FIG. 5.

When switching from a feed without hydronormalization to one with hydro-normalization, a dramatically lower feed rate (ton/hr) is needed to reach the same desirable ethylene (C₂H₄) yield. At this feed rate, the hydronormalized feed exhibits a shift toward desirable olefins (C₂H₄, C₃H₆, C₄H₈) and aromatics (benzene, toluene, xylenes or BTX) at the cost of heavier products (particularly pyrolysis fuel oil or PFO) (see Table 2 below). This amounts to a dramatic increase in carbon and energy efficiency of the steam cracking process while providing enhanced circularity at maximum yield.

TABLE 2

| | Original Feed | | Hydroprocessed | |
|---|---|---|---|---|
| | High Sev | Low Sev | High Sev | Low Sev |
| Feed, T/h | 324.1 | 392.7 | 307.7 | 379.1 |
| H2 | 2.4 | 2.2 | 2.4 | 2.1 |
| CH4 | 37.2 | 34.2 | 37.1 | 33.6 |
| C2H4 | 100 | 100 | 100 | 100 |
| C3H6 | 46.1 | 62.2 | 41.9 | 61.3 |
| C4H6 | 18.2 | 21.9 | 17.8 | 21.7 |
| C4H8 | 11.4 | 24 | 9.8 | 23.8 |
| C4H10 | 0.4 | 0.6 | 0.4 | 0.6 |
| C5-400 F. PGO | 61.4 | 77.2 | 58.1 | 76.3 |
| 400 F. + PFO | 47 | 70.4 | 40.4 | 59.8 |
| Selectivity, w/w | | | | |
| C2H4 | 30.86 | 25.46 | 32.5 | 26.38 |
| C2H4 + C3H6 | 45.07 | 41.3 | 46.12 | 42.53 |
| C2H4 + C3H6 + C4H8 | 50.69 | 46.87 | 51.9 | 48.27 |
| BTX | 12.08 | 7.44 | 12.6 | 7.45 |

As used in this disclosure the word “comprises” or “comprising” is intended as an open-ended transition meaning the inclusion of the named elements, but not necessarily excluding other unnamed elements. The phrase “consists essentially of” or “consisting essentially of” is intended to mean the exclusion of other elements of any essential significance to the composition. The phrase “consisting of” or “consists of” is intended as a transition meaning the exclusion of all but the recited elements with the exception of only minor traces of impurities.

As those skilled in the art will appreciate, numerous modifications and variations of the present invention are possible in light of these teachings, and all such are contemplated hereby. For example, in addition to the embodiments described herein, the present invention contemplates and claims those inventions resulting from the combination of features of the invention cited herein and those of the cited prior art references which complement the features of the present invention. Similarly, it will be appreciated that any described material, feature, or article may be used in combination with any other material, feature, or article, and such combinations are considered within the scope of this invention.

All of the publications cited in this disclosure are incorporated by reference herein in their entireties for all purposes.

What is claimed is:

1. A continuous process for converting waste plastics back into chemical building blocks through integrating pyrolysis and hydroprocessing comprising:
(a) selecting a circular feedstock;
(b) passing the circular feedstock through a pyrolysis reactor to produce a pyrolyzed effluent;
(c) separating the pyrolyzed effluent into off-gas, pitch or char, and a circular pyrolysis oil;
(d) subjecting the circular pyrolysis oil to a hydrodehalogenation or a hydrolysis step to reduce halogen content to 5 wt-ppm or lower;
(e) passing the circular pyrolysis oil from (d) to a hydroconversion reactor comprising a hydroconversion catalyst based on a LTA-type zeolite;
(f) recovering hydrocarbons enriched in linear paraffins from ethane through n-hexane from the hydroconversion reactor; and
(g) passing the hydrocarbons from (f) to a steam cracker for olefin and aromatics production.

2. The process of claim 1, wherein at least some contaminants are removed from the recovered circular pyrolysis oil of step (c) before the oil is passed to the hydrodehalogenation in (d).

3. The process of claim 1, wherein the LTA zeolite has an acid site concentration in the range of from 2.6 mol/l to 3.0 mol/l, or from 2.6 mol/l to 2.8 mol/l, or about 2.7 mol/l.

4. The process of claim 1, wherein the LTA zeolite catalyst converts n-C₇⁺ paraffins into linear paraffins in the C₂-C₆ range and/or wherein the hydroconversion process in e) enriches the hydroprocessed product stream by at least 2 wt. %, or by at least 3 wt. % or by at least 4 wt. % in C₂-C₆ n-paraffins; and/or wherein the n-paraffins in e) comprises at least 5 wt. %, or at least 10 wt. % C₇⁺ normal paraffins.

5. The process of claim 1, wherein the LTA zeolite catalyst, optionally, shaped with a binder into a pellet, is loaded with a hydrogenation function metal, wherein the hydrogenation function metal comprises a noble metal; or the hydrogenation function metal comprises Pd, Pt, Re, Ru, Sn, Au or a mixture thereof; or the hydrogenation function metal comprises Ni, Co, Mo, W, their sulfides, or a mixture thereof; or wherein the LTA zeolite catalyst comprises mixed metal sulfides.

6. The process of claim 1, wherein the LTA zeolite catalyst comprises a binder, such as an alumina.

7. The process of claim 1, wherein the halogen content in step (d) is reduced to below 1 ppm.

8. The process of claim 1, wherein the circular feedstock derives from waste plastics from industry and/or consumer waste.

9. The process of claim 8, wherein the waste plastics comprises polyethylene, polypropylene and/or styrene.

10. The process of claim 1, wherein a product recovered from the steam cracker in (g) comprises a lower olefin or an aromatics compound.

11. The process of claim 10, wherein the lower olefin comprises ethylene, propylene or butene.

12. The process of claim 10, wherein the aromatics comprise benzene, toluene, xylenes, or BTX.

13. The process of claim 1, wherein ethylene is recovered from the steam cracker and passed to ethylene polymerization to make polyethylene.

14. The process of claim 1, wherein the hydroconversion in (e) may be run for at least 3 months, or at least 6 months, or at least 2 years without changing the LTA catalyst or regenerating the LTA catalyst.
